(19) United States
(12) Patent Application Publication
(10) Pub. No.: US 2015/0028155 A1
(43) Pub. Date: Jan. 29, 2015

(54) WING ADJUSTING MECHANISM

(71) Applicant: Johannes Reiter, Laakirchen (AT)

(72) Inventor: Johannes Reiter, Laakirchen (AT)

(21) Appl. No.: 14/378,633

(22) PCT Filed: Feb. 13, 2013
(86) PCT No.: PCT/EP2013/052911

§ 371 Date: Aug. 13, 2014

(30) Foreign Application Priority Data
Feb. 13, 2012 (GB) 1202441.0

(51) Int. Cl. B64C 27/00; B64C 3/38; B64C 29/00

(52) U.S. Cl. CPC B64C 27/00; B64C 29/00; B64C 3/385; B64C 27/001
USPC 244/39

(57) ABSTRACT

The present invention relates to a device for generating aerodynamic lift and in particular an aircraft (100) for vertical take-off and landing. A wing arrangement (110) comprises at least one propulsion unit (111), wherein the propulsion unit (111) comprises a rotating mass which is rotatable around a rotary axis (117). The wing arrangement (110) is mounted to a fuselage (101) such that the wing arrangement (110) is tiltable around a longitudinal wing axis (112) of the wing arrangement (110) and such that the wing arrangement (110) is rotatable with respect to the fuselage (101) around a further rotary axis that differs to the longitudinal wing axis (112). An adjusting mechanism adjusts a tilting angle of the wing arrangement (110) around the longitudinal wing axis (112) under influence of a precession force (Fp) which forces the wing arrangement (110) to tilt around the longitudinal wing axis (112).

### FIELD OF THE INVENTION

The present invention relates to an aircraft for vertical take-off and landing and to a method for operating an aircraft for vertical take-off and landing.

### BACKGROUND OF THE INVENTION

It is an aim to have aircraft that are able to start and land without a runaway for example. Hence, in the past several developments for so called Vertical Take-Off and Landing aircraft (VTOL) have been done. Conventional VTOL-Aircraft need a vertical thrust for generating the vertical lift. Extreme thrust for vertical take-off may be produced by big propellers or jet engines. Propellers may have the disadvantage in travel flight of an aircraft due to a high drag.

An efficient solution for a hover flight capable aircraft is performed by helicopters, using e.g. a big wing area. In a known system, an aircraft comprises an engine for vertical lifting the aircraft (e.g. a propeller) and e.g. a further engine for generating the acceleration of the aircraft in a travel mode up to a desired travelling speed.

In the hover flight mode, the rotating wings or blades of an aircraft (e.g. a helicopter) generate the vertical lift. The rotating wings comprise a chord line, wherein an angle between the chord line and the streaming direction of the air may be called angle of attack. A higher angle of attack generates a higher lift and a lower angle of attack generates a lower lift but also less drag. In order to achieve a higher efficiency of the rotating wings it may be helpful to adjust the angle of attack. Thus, the wings may be tilted around its longitudinal axis.

In order to control and to drive such a tilting of the wings, complex and energy consuming adjustment mechanics, such as hydraulic or electric driving systems, are used, which increase weight and the error rate of the adjustment mechanics.

### OBJECT AND SUMMARY OF THE INVENTION

It may be an object of the present invention to provide a proper wing adjustment mechanic.

This object may be solved by a device for generating aerodynamic lift, an aircraft for vertical take-off and landing and by a method for operating such an aircraft according to the independent claims.

According to a first aspect of the present invention, a device for generating aerodynamic lift is presented. The device comprises a wing arrangement, which comprises at least one propulsion unit. The propulsion unit comprises a rotating mass which is rotatable around a rotary axis, wherein the wing arrangement is tiltable around a longitudinal wing axis of the wing arrangement. The wing arrangement is rotatable around a further rotary axis that differs to the longitudinal wing axis. The device further comprises an adjusting mechanism for adjusting a tilting angle of the wing arrangement around the longitudinal wing axis under influence of a precession force which forces the wing arrangement to tilt around the longitudinal wing axis. The precession force results inter alia from a rotation of the wing arrangement around the further rotary axis and a rotation of the rotating mass around the rotary axis.

According to a further aspect of the present invention an aircraft for vertical take-off and landing is presented. The aircraft comprises the above mentioned device and a fuselage.

The wing arrangement is mounted to the fuselage such that the wing arrangement is tiltable around a longitudinal wing axis of the wing arrangement and such that the wing arrangement is rotatable with respect to the fuselage around the further rotary axis that differs to the longitudinal wing axis.

According to a further aspect of the present invention a method for operating the above described aircraft for vertical take-off and landing is described. According to the method, a tilting angle of the wing arrangement under influence of the precession force which forces the wing arrangement to tilt around the longitudinal wing axis is adjusted.

The propulsion unit may be a jet engine, a turbo jet engine, a turbo fan, a turbo prop engine, a prop fan engine, a rotary engine and/or a propeller engine. In particular, the propulsion unit described herewith will be a propulsion unit which comprises rotating masses which are rotatable around a rotary axis. The rotating mass may be for example a propeller and/or a turbine stage (rotating turbine blades) which rotates around the rotary axis.

The rotary axis may be for example the driving shaft of a propeller engine and/or a turbine shaft of a jet engine, for example. The rotary axis may be non-parallel to the longitudinal wing axis. Additionally or alternatively, the rotary axis may be non-parallel to the further rotary axis (e.g. the fuselage axis). The propulsion unit may pivotable around the longitudinal wing axis with respect to and relative to the wing arrangement or together with the wing arrangement.

In an exemplary embodiment, the propulsion unit may be adapted for generating a thrust of 3 kg to 5 kg (kilograms). In the hover flight mode, approximately 25 kg are liftable. The aircraft for vertical take-off and landing may thus have a thrust-to-weight ratio of approximately 0.2 to 0.4, preferably 0.3.

The wing arrangement comprises a longitudinal wing axis, wherein the longitudinal wing axis is the axis around which the wing arrangement is tiltable with respect to the fuselage. The longitudinal wing axis may be defined by the run of a main wing spar or by a bolt that connects for example a wing root of the wing arrangement with the fuselage. The wing arrangement is mounted at the wing root to the fuselage, wherein at an opposite end of the wing with respect to the wing root a wing tip is defined, which is a free end of the wing arrangement. The longitudinal wing axis may be parallel e.g. with a leading edge or a trailing edge of the wing arrangement. Moreover, the longitudinal wing axis may be an axis that is approximately perpendicular to a fuselage longitudinal axis (e.g. the further rotary axis).

The wing arrangement may comprise a first wing, a second wing or a plurality of wings. Each wing may comprise an aerodynamical wing profile comprising a respective leading edge where the air impinges and a respective trailing edge from which the air streams away from the wing. A chord line of the wing arrangement and the wings, respectively, refers to an imaginary straight line connecting the leading edge and the trailing edge within a cross-section of an airfoil. The chord length is the distance between the trailing edge and the leading edge.

The fuselage describes a main body of the aircraft, wherein in general the centre of gravity of the aircraft is located inside the area of the fuselage. The fuselage may be in one exemplary embodiment of the present invention a small body to which the wing arrangement is rotatably mounted, so that the aircraft may be defined as a so-called flying wing aircraft. In particular, the fuselage may be a section of the wing and the fuselage may comprise a length equal to the chord line (e.g. a width) of the wing. Alternatively, the fuselage comprises a length that is longer than e.g. the chord line (e.g. the width) of the wing that connects the leading edge and the trailing edge. The fuselage comprises a nose and a tail section.

The further rotary axis is the rotary axis around which the wing arrangement rotates, e.g. around the fuselage. The further rotary axis may be in an exemplary embodiment the longitudinal fuselage axis (longitudinal symmetry axis) of the fuselage. In an exemplary embodiment, the further rotary axis may comprise an angle between the longitudinal fuselage axis and may thus run non-parallel to the longitudinal fuselage axis.

In a hover flight mode, the wing arrangement is rotating around the further rotary axis around the fuselage, so that due to the rotation of the wing through the air a lift is generated even without a relative movement of the aircraft (i.e. the fuselage) through the air. Hence, by rotating the wing arrangement through the air, a hover flight mode is achievable. The fuselage may be rotatable together with the wing arrangement around the further rotary axis. Alternatively, the wing arrangement may be rotatable with respect to the fuselage, so that only the wing arrangement rotates in the hover flight mode for generating lift. Moreover, if the wing arrangement rotates in the hover flight mode, a stabilizing moment (e.g. a gyroscopic moment, i.e. a conservation of angular momentum) for stabilizing the aircraft is generated. In a fixed-wing flight mode, the wing arrangement is fixed to the fuselage without having a relative motion between the wing arrangement and the fuselage, so that by a forward motion of the aircraft through the air the lift is generated by the wing arrangement by a forward movement of the wing arrangement through the air.

The wing arrangement rotates through the air and the air has a defined streaming direction with respect to the wing arrangement. The so-called angle of attack defines the alignment of the wing arrangement with respect to the streaming direction of the air, through which the wing arrangement moves. The angle of attack is defined by an angle between the cord line of the wing arrangement and the streaming direction of the air which attacks and impinges at the leading edge of the wing arrangement. If the angle of attack is increased, the coefficient of lift c is increased till a critical angle of attack is reached, where generally stall occurs.

The device may be a part of an aircraft as described above. Furthermore, the device may be spatially fixed with respect to a holding device for holding the device or to a ground, respectively, and thus form a ventilator, an air blower, a turbine stage or a compressor.

Hence, in order to control the device adequately it is necessary to adjust a predefined lift of the device. The lift of the device may be defined for example by the rotational speed of the wing arrangement around the further rotary axis and by adjusting the angle of attack. The term “lift” denotes a force which forces the device to move along a defined direction, e.g. horizontally or vertically. If the device is spatially fixed, the lift generates an air stream by the rotating wing arrangement, for example. If the device is not spatially fixed, the lift may result in a movement of the device through the air.

By the present invention, the adjusting mechanism adjusts a tilting angle (and hence a defined angle of attack) of the wing arrangement in an efficient and simplified manner. In order to adjust the tilting angle of the wing arrangement, the precession force is used. Further driving mechanisms which actively drive and tilt the wing arrangement around its longitudinal wing axis may be obsolete.

The adjusting mechanism may comprise a coupling mechanism which adjusts the tilting angle of the wing arrangement and/or couples the wing arrangement to the fuselage, wherein the adjusting mechanism provides a relative rotation of the wing arrangement around the longitudinal wing axis and/or a movement of the wing arrangement with respect to the fuselage around the longitudinal wing axis, such that the precession force may tilt the wing arrangement around the longitudinal wing axis.

The adjusting mechanism may comprise guiding elements, such as guiding rails or guiding grooves, into which for example corresponding bolts, the (main) wing spar or other guiding elements may be engaged for providing a guided and controlled relative movement between the wings and the fuselage around the longitudinal wing axis. For example, in an exemplary embodiment, the (main) wing spar may be fixed to the fuselage and the bolt may be coupled to the guiding groove such that a movement of the bolt along the guiding groove causes a rotation of the wing around the main wing spar.

The precession force results from a rotation of the wing arrangement around the further rotary axis and from a rotation of the rotating mass around the rotary axis of the propulsion unit. The rotating mass, such as the propeller, tries to drive the propulsion unit and the wing arrangement along a linear and tangential direction with respect to a circumferential path around the further rotary axis. Due to the rotation of the wing arrangement around the further rotary axis, the propulsion unit is forced to rotate around the further rotary axis as well, so that a constraint force forces the propulsion unit to leave its desired longitudinal and tangential direction and to move along the circumferential path around the further rotary axis. Because this further force (constraining force) acts on the rotating mass which rotates around the rotary axis, the precession force is generated. The precession force acts along a direction which is approximately perpendicular)(90° shifted with respect to the further force along the rotary direction of the rotating mass around the rotary axis.

The precession force may be dependent on the rotational speed of the rotating mass around the rotary axis, the weight, the rotational speed of the wing arrangement around the further rotary axis and the center of gravity of the rotating mass and the rotating speed of the wing arrangement around the further rotary axis.

The adjusting mechanism may be adapted such that the precession force forces the wing arrangement to tilt with a first rotary direction around the longitudinal wing axis. E.g. the lifting force which acts onto the wing arrangement forces the wing arrangement to rotate around the longitudinal wing axis, which may direct from the root end to the free end of the wing arrangement, with a second rotary direction, wherein the first rotary direction is directed opposed to the second rotary direction. Hence, the tilting angle of the wing arrangement is dependent on a balance of the turning moment generated by the precession force and an opposite directed turning moment generated by the lifting force.

If the turning moment of the lifting force is lower than the turning moment of the precession force, the precession force dominates the tilting of the wing arrangement around the longitudinal wing axis, such that the longitudinal wing axis will tilt around the longitudinal wing axis and the angle of attack may be increased. The increasing of the angle of attack increases also the lifting force. A constant tilting angle of the wing arrangement is achieved, if the turning moment of the lifting force is balanced with the turning moment of the precession force.

If, for example, the turning moment of the lifting force is higher than the turning moment of the precession force, the lifting force dominates the tilting of the wing arrangement around the longitudinal wing axis. Hence, the wing arrangement tilts around the longitudinal wing axis such that the angle of attack may be reduced. Hence, the lifting force will be reduced until the turning moment of the lifting force is balanced with the turning moment of the precession force. If the balance point between the precession force and the lifting force is adjusted, a constant and desired tilting angle of the wing arrangement is achieved. If, for example, the angle of attack is reduced, the drag is reduced as well which results in that the rotational speed of the wing arrangement around the further rotary axis (if applying a constant driving torque to the wing arrangement) increases. The balance point is particularly dependent on the rotational speed of the rotating mass of the propulsion unit.

Hence, by providing an adjusting mechanism as described above, a simple regulation of the angle of attack of the tilting angle of the wing arrangement around its longitudinal wing axis is achieved. Simply by using the precession force, a desired tilting angle of the wing arrangement around the longitudinal wing axis is adjusted. The precession force is dependent for example on the rotational speed of the wing arrangement of the further rotary axis and a rotational speed of the rotating mass around the rotary axis. Hence, the amount of the precession force may be adjusted by controlling the rotation of the wing arrangement around the further rotary axis or by controlling the propulsion unit, i.e. the rotating speed of the rotating mass (propeller) around the rotary axis. Furthermore, by the above described adjusting mechanism, an adapted tilting angle is adjustable automatically and self acting by adjusting a balance of the respective turning moments of the precession force and of the lifting force. If the turning moment generated by the lifting force is too low and the turning moment generated by the precession force is higher than the turning moment generated by the lifting force, the precession force increases the angle of attack of the wing arrangement, such that the lift is increased and vice-versa. Hence, an automatic and self acting regulation of the lifting force by the generation of the precession force is achieved without a complex adjusting unit.

According to a further exemplary embodiment, the precession force forces the wing arrangement to tilt around the longitudinal wing axis with a first rotary direction. The adjusting mechanism comprises a controlling element with a controlling force which acts in counter direction or in the same direction with respect to the first rotary direction for controlling the tilting of the wing arrangement.

According to an exemplary embodiment, the controlling element comprises a hydraulic damper, a pneumatic damper, a (extension or compression) spring and/or a servo motor.

Hence, by applying a controlling element, such as a spring, for example, the balance point, where the the turning moment of the precession force is balanced with the the turning moment of the lifting force may be influenced. For example, if a higher lifting force is desired to be achieved on the basis of a predetermined rotation of the wing arrangement around the further rotary axis of the fuselage and/or on the basis of a predetermined rotation speed of the rotation of the rotating mass around the rotary axis, the controlling element is adjusted for providing a higher or lower controlling force. Hence, by using the controlling element, the angle of attack of the wing arrangement may be set higher or lower under a predetermined precession force. Hence, due to the higher angle of attack a higher lifting force is achieved by the tilting angle of the adjusting mechanism.

According to a further exemplary embodiment the aircraft comprises a control device which is adapted for controlling the controlling force. In a further exemplary embodiment, the control device is adapted for controlling the controlling force on the basis of data which are indicative of a rotational speed of the rotating mass (propellers, turbine blades) of the propulsion unit around the rotary axis, a rotation speed of the wing arrangement around the further rotary axis, the weight, the flight altitude, the (wing/fuselage) geometry and an angle of attack of the wing arrangement. The values for the described parameters may be measured by sensor systems which comprises sensors that are located at adequate locations of the aircraft.

Hence, by providing the above described control device, parameters (data) indicative of a desired lifting force and/or a desired height of the aircraft may be inputted into the control device. Therefore, the control device calculates on the basis of the above described parameters and data (e.g. the rotational speed of the rotating mass, rotational speed of the wing arrangement, angle of attack) the necessary and required values for the parameters for generating the required precession force which causes an adjustment of a required angle of attack such that the desired lifting force results.

Hence, a proper control mechanism and adjusting mechanism is achieved without needing additional mechanics for actively adjusting the wing arrangement and to counteract the lifting force, for example.

According to a further exemplary embodiment, the aircraft comprises a sleeve to which the wing arrangement is mounted. The sleeve is slidably mounted to the fuselage such that the sleeve is slideable along a surface (i.e. along a centre axis of the fuselage) of the fuselage and such that the sleeve is rotatable around the further rotary axis.

The wing arrangement is attached by the sleeve to the fuselage. By using the sleeve, the wing arrangement may e.g. surround the fuselage and may not run through the fuselage, e.g. for fixing purposes. Hence, a relative motion between the wing arrangement and the fuselage by using the sleeve is achieved. The wing arrangement is rotatably fixed to the circumferential surface of the fuselage by the sleeve. The sleeve may be a closed or open sleeve to which the wing arrangement is attached, e.g. at the outer surface of the sleeve. Furthermore, the sleeve is slideably clamped (e.g. by its inner surface) to the outer surface of the fuselage, wherein between the sleeve and the fuselage a slide bearing is formed. Besides the slide bearing, the sleeve and the outer surface of the fuselage may be adapted to form e.g. a ball bearing, so that abrasion is reduced.

Between the inner surface of the sleeve and the outer surface of the fuselage, a bearing ring may be interposed which is non-rotatably fixed either to the fuselage or to the wing arrangement. For example, the sleeve may be slidable with respect to the bearing ring, wherein the bearing ring is fixed to the fuselage without being slidable.

Alternatively, according to a further exemplary embodiment, the bearing ring is slidably mounted to the fuselage such that the bearing ring is slideable along a surface of the fuselage and such that the bearing ring is rotatable around the further rotary axis. The sleeve may rotate together with the bearing ring around the further rotary axis.

Further alternatively, according to a further exemplary embodiment, the bearing ring is rotatably mounted to the fuselage such that the bearing ring is rotatable around the centre axis (or the further rotary axis) of the fuselage but wherein the bearing ring is mounted to the fuselage such that the bearing ring is not moveable along the centre axis (or the further rotary axis). The sleeve to which the wing arrangement is mounted is moveable with respect to the bearing ring along the centre axis (or the further rotary axis) and the sleeve rotates together with the bearing ring around the centre axis (or the further rotary axis).

The bearing ring may comprise roller bearing elements, which are located between the bearing ring and the fuselage surface, such that the bearing ring is rotatable around the fuselage.

For providing the above described fixation of the wing arrangement to the fuselage, according to a further exemplary embodiment, the aircraft comprises a first fixing element (e.g. a first bolt) and a second fixing element (e.g. a second bolt). The sleeve comprises an elongated through hole, which may have an extension approximately parallel to the centre axis (or the further rotary axis). The first fixing element and the second fixing element are coupled, e.g. in a rotatable manner, spatially apart from each other to the wing arrangement. The first fixing element is further coupled to the sleeve and the second fixing element is further coupled through the elongated through hole to the fuselage or the bearing ring, respectively. The first fixing element and the second fixing element may be for example a first bolt and a second bolt or a first wing spar and a second wing spar, respectively. Respective first ends of the first and second fixing elements are for example rotatably coupled to a root section of the wing arrangement. The opposed ends of the respective first and second fixing elements are for example rotatably coupled to the sleeve and rotatably fixed to the fuselage or the bearing ring.

The second fixing element which couples the wing arrangement to the fuselage or the bearing ring forms a pivot point through which the longitudinal wing axis (i.e. a wing rotary axis) of the wing arrangement runs. The wing arrangement is thus rotatable around the pivot point.

For example, if the sleeve is moved along the surface of the fuselage or the bearing ring, e.g. along the further rotary axis, the first fixing element (e.g. bolt) moves together with the sleeve, whereas the second fixing element (e.g. bolt) which is fixed to the fuselage or the bearing ring does not move along the further rotary axis. Hence, by moving the sleeve and hence the first fixing element along the fuselage, the wing arrangement pivots around the pivot point, e.g. around the longitudinal wing axis. The tilting of the wing arrangement around the longitudinal wing axis and hence the movement of the sleeve along the bearing ring or the fuselage, respectively, is initiated by the precession force, the lifting force and/or the control force until a balance between the turning moment generated by the precession force, the turning moment generated by the lifting force and/or the turning moment generated by the control force with respect to the pivot axis is achieved.

By the above described fixing mechanism for the wing arrangement to the fuselage, a robust mechanism for the adjusting mechanism is formed.

According to a further exemplary embodiment, the wing arrangement is adapted in such a way that in a fixed wing flight mode, the wing arrangement does not rotate around a further rotary axis. The wing arrangement is further adapted in such a way that in a hover flight mode, the wing arrangement is tilted around the longitudinal wing axis with respect to its orientation in the fixed wing flight mode and the wing arrangement is further adapted in such a way that the wing arrangement rotates around the further rotary axis.

In particular, in the hover flight mode, the wing arrangement rotates for generating lift. In the fixed-wing flight mode, the wing arrangement is fixed to the fuselage without having a relative motion between the wing arrangement and the fuselage, so that by a forward motion of the aircraft the lift is generated by the wing arrangement which is moved through the air. Additionally, a further wing arrangement which is spaced apart to the wing arrangement along the longitudinal fuselage axis may be attached to the fuselage.

Hence, by the exemplary embodiment, a vertical take-off and landing aircraft is presented which combines the concept of a fixed-wing flight mode aircraft and a hover flight mode aircraft. Hence, both advantages of each flight mode may be combined. For example, a fixed-wing flight aircraft is more efficient during the cruise flight, i.e. when the aircraft moves through the air. On the other side, in the hover flight mode of the aircraft, the wing rotates such as wings or blades of a helicopter, so that the wing itself generates the lifting force in the hover flight mode. This is more efficient due to the large wing length in comparison to lift generating propulsion engines in known VTOL aircraft. For example, known VTOL aircraft generate the lift by engine power and not by the aerodynamic lift of the rotation of the wing.

According to a further exemplary embodiment, the wing arrangement comprises a first wing and a second wing. The longitudinal wing axis is split in a first longitudinal wing axis and a second longitudinal wing axis. The first wing extends along the first longitudinal wing axis and the second wing extends along the second longitudinal wing axis from the fuselage. The first wing is tiltable with the first rotational direction around the first longitudinal wing axis and the second wing is tiltable with a second rotational direction around the second longitudinal wing axis.

According to a further exemplary embodiment, the first rotational direction differs to the second rotational direction.

In the hover flight mode, the first longitudinal wing axis and the second longitudinal wing axis are oriented substantially parallel and e.g. coaxial. In the fixed-wing flight mode, the first longitudinal wing axis and the second longitudinal wing axis may also extend parallel to each other. In an alternative embodiment the first longitudinal wing axis and the second longitudinal wing axis may run non-parallel with respect to each other, so that an angle between the first longitudinal wing axis and the second longitudinal wing axis is provided. If the first longitudinal wing axis and the second longitudinal wing axis comprise an angle between each other, the first wing and the second wing may form a wing sweep, in particular a forward swept, a swept, an oblique wing or a variable swept (swing wing).

According to a further exemplary embodiment of the aircraft, the first rotational direction of the first wing differs to the second rotational direction of the second wing. In particular, if the first wing extends from one side of the fuselage and the second wing extends from the opposed side of the fuselage, and the first wing and the second wing rotates around the further rotary axis, i.e. the longitudinal fuselage axis, it is necessary that the respective wing edges, i.e. the leading edges of the wings, are moved through the air such that the air impacts (attacks) at the leading edge instead of the trailing edge, so that lift is generated by the wing profile. Hence, for the transformation of the aircraft from the fixed-wing flight modus to the hover flight modus, the first wing may rotate around its first wing longitudinal axis around 60° (degrees) to 120°, in particular approximately 90°, in the first rotational direction and the second wing may be tilted around 60° (degrees) to 120°, in particular approximately 90°, around the second wing longitudinal axis in the second rotational direction, which is an opposed direction with respect to the first rotational direction.

In an alternative embodiment it is as well possible that the first rotational direction and the second rotational direction are equal.

The aircraft according to the present invention may be a manned aircraft or an unmanned aircraft vehicle (UAV). The aircraft may be e.g. a drone that comprises for example a wing span of approximately 1 m to 4 m (meter) with a weight of approximately 4 kg to 200 kg (kilograms).

In particular, according to an exemplary embodiment of the method, the precession force (Fp) is controlled by:
a) controlling a rotational speed of the rotating mass of the propulsion unit around the rotary axis,
b) controlling a rotational speed of the wing arrangement around the further rotary axis and an angle of attack of the wing arrangement,
c) controlling the weight balance of the rotating mass, and/or
d) controlling an angle between the rotary axis, the further rotary axis and/or the longitudinal wing axis.

In a preferred exemplary embodiment, exclusively the rotational speed and/or the thrust of the propulsion unit, respectively, is controlled for controlling the aircraft in the hover-flight mode. Hence, a simplified control dynamic for the aircraft in the hover-flight mode is achieved.

It has to be noted that embodiments of the invention have been described with reference to different subject matters. In particular, some embodiments have been described with reference to apparatus type claims whereas other embodiments have been described with reference to method type claims. However, a person skilled in the art will gather from the above and the following description that, unless other notified, in addition to any combination of features belonging to one type of subject matter also any combination between features relating to different subject matters, in particular between features of the apparatus type claims and features of the method type claims is considered as to be disclosed with this application.

### BRIEF DESCRIPTION OF THE DRAWINGS

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

FIG. 1 shows a schematical view of an aircraft in a hover flight mode according to an exemplary embodiment of the present invention;

FIG. 2 shows a schematical view of an adjusting mechanism according to an exemplary embodiment of the present invention;

FIG. 3 shows a schematical view of an aircraft in a hover flight mode according to an exemplary embodiment of the present invention;

FIG. 4 shows a schematical view of an aircraft in a fixed wing flight mode according to an exemplary embodiment of the present invention; and

FIG. 5 shows an exemplary embodiment of the device for generating an aerodynamic lift according to an exemplary embodiment of the present invention.

### DESCRIPTION OF EXEMPLARY EMBODIMENTS

The illustration in the drawing is schematically. It is noted that in different figures, similar or identical elements are provided with the same reference signs.

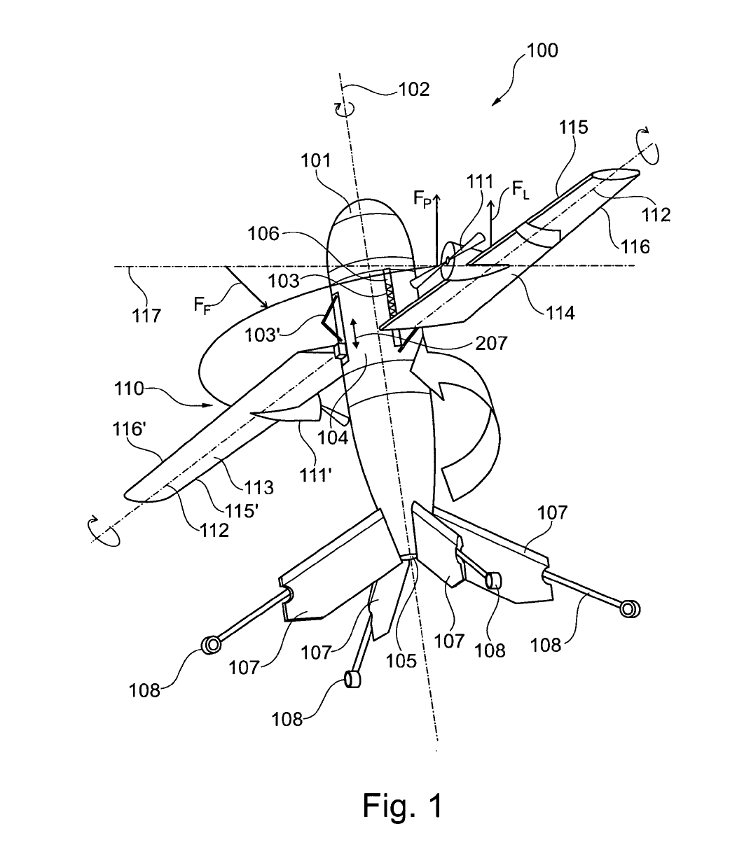

FIG. 1 shows an exemplary embodiment of an aircraft 100 for vertical take-off and landing according to an exemplary embodiment of the present invention. The aircraft 100 comprises a fuselage 101, a wing arrangement 110 which comprises at least one propulsion unit 111 and an adjusting mechanism.

The propulsion unit 111 comprises a rotating mass (e.g. a propeller or rotating blades of a jet engine) which is rotatable around a rotary axis 117. The wing arrangement 110 is mounted to the fuselage 101 such that the wing arrangement 110 is tiltable around a longitudinal wing axis 112 of the wing arrangement 110. Furthermore, the wing arrangement 110 is mounted to the fuselage 101 such that the wing arrangement 110 is rotatable with respect to the fuselage 101 around a further rotary axis 102 (e.g. a longitudinal fuselage axis) that differs to the longitudinal wing axis 112. For example, the further rotary axis 102 is approximately perpendicular to the longitudinal wing axis 112.

The adjusting mechanism is adapted for adjusting a tilting angle of the wing arrangement 110 around the longitudinal wing axis 112 under influence of a precession force Fp which forces the wing arrangement 110 to tilt around the longitudinal wing axis 112 such that a predefined angle of attack α of the wing arrangement 110 is adjustable. The precession force Fp results from a rotation of the wing arrangement 110 around the further rotary axis 102 and a rotation of the rotating mass around the rotary axis 117.

The wing arrangement 110 comprises for example a first wing 113 and a second wing 114. Each of the wings 113, 114 comprises a respective leading edge 115, 115′ and a respective trailing edge 116, 116′.

The propulsion units 111, 111′ force the respective wings 113, 114 to rotate around the further rotary axis 102. By the rotation of the wings 113, 114 around the further rotary axis 102 a lifting force Fl is generated such that the aircraft 100 may fly and hover through the air such as a helicopter, for example.

The tilting angle of the wings 113, 114 around the respective longitudinal wing axis 112 is adjusted by the adjusting mechanism under influence of the precession force Fp. The precession force Fp results from a rotation and a rotational speed of the wing arrangement 110 around the further rotary axis 102 and a rotation and a rotational speed of the rotating mass around the rotary axis 117.

If the second wing 114 rotates for example around the further rotary axis 102, the propulsion unit 111 with its rotating mass is forced to leave a linear direction (which may be coaxial with the rotary axis 117) and is forced to move along a circumferential path around the fuselage 101. Hence, a further force Ff results which forces the propulsion unit 111 to move along the circumferential path. The further force Ff acts in particular on the rotating mass of the propulsion unit 111 such that the precession force results. At least one component of the precession force is directed 90° in direction of rotation of the rotating mass with respect to the further force Ff. As shown in FIG. 1, at least a component of the precession force Fp may act along the fuselage axis (i.e. the further rotary axis 102).

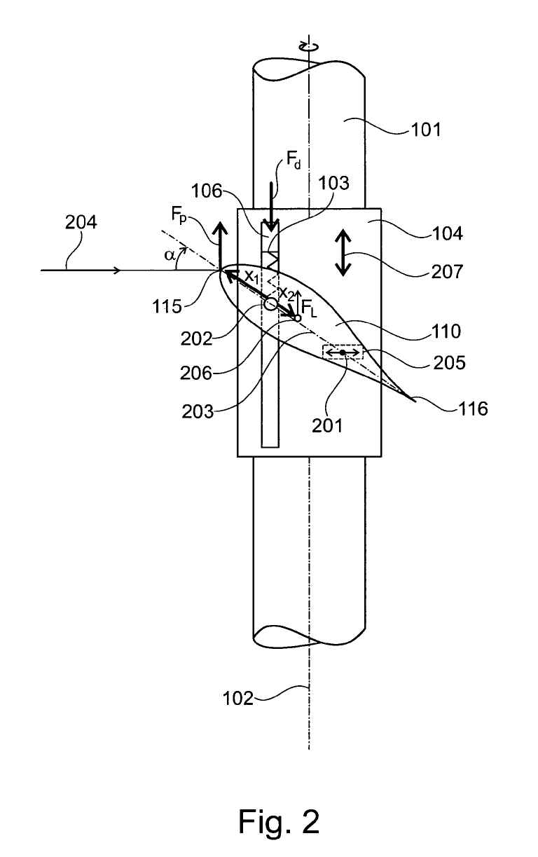

The precession force Fp acts on the rotary axis 117 where the rotating mass comprises its pivot point on the rotary axis 117. FIG. 1 shows the resultant of the lifting force Fl. By the adjusting mechanism, the longitudinal wing axis 112 is defined between the attacking point of the precession force Fp and the attacking location of the resultant of the lifting force Fl along a chord line 203 (see FIG. 2). In other words, a pivotal axis (i.e. the longitudinal wing axis 112) of the respective wings 113, 114 is formed between the point of attack of the precession force and the point of attack of the lifting force.

Hence, if the turning moment generated by the precession force Fp is higher than the turning moment generated by the lifting force Fl, the respective wing 113, 114 rotates around the longitudinal wing axis 112. Thereby, the angle of attack α, which is shown in more detail in FIG. 2, increases and the lifting force Fl increases as well. If the turning moment generated by the precession force Fp and the turning moment generated by the lifting force Fl are balanced, a desired tilting angle of the wing arrangement 110, i.e. of the first wing 113 and of the second wing 114, is achieved.

The amount of the precession force Fp is controllable by the rotational speed of the rotating masses of the propulsion unit 111 and the rotational speed of the wing arrangement 110 around the further rotary axis 102. Hence, by controlling one of the rotational speeds, the precession force Fp and thereby the angle of attack and the lifting force Fl may be controlled. Hence, by the adjusting mechanism a desired tilting angle of the wing arrangement 110 and hence a desired lifting force Fl may be adjusted such that the aircraft 100 may be controlled in a simple manner. Complex driving mechanisms for adjusting for example a tilting angle may not be necessary.

The coupling of the wing arrangement 110 rotatably to the fuselage 101 may be achieved by applying a sleeve 104 which is rotatably mounted to the fuselage 101. A second fixing element 202 (see FIG. 2) may be guided through an elongated through hole 106 of the sleeve 104. A first fixing element 201 (see FIG. 2) and the second fixing element 202 are coupled, e.g. in a pivotable manner, spatially apart from each other to the wing arrangement 110. The first fixing element 201 is further coupled to the sleeve 104 and the second fixing element 202 is further coupled through the elongated through hole 106 to the fuselage 101 or a bearing ring, respectively. The bearing ring is interposed between the sleeve 104 and the fuselage 101. The first fixing element 201 and the second fixing element 202 may be for example a first bolt and a second bolt or a first wing spar and a second wing spar, respectively. Respective first ends of the first and second fixing elements 201, 202 are for example rotatably coupled to a root section of the wing arrangement 110. The opposed ends of the respective first and second fixing elements 201, 202 are for example rotatably coupled to the sleeve 104 and rotatably fixed to the fuselage 101 or the bearing ring.

The bearing ring may be fixed to the fuselage 101 such that the bearing ring is not rotatable around the fuselage 101. Hence, the sleeve 104 is coupled to the bearing ring such that the sleeve 104 is rotatable around the bearing ring. Alternatively, the bearing ring is coupled to the fuselage 101 such that the bearing ring is rotatable around the fuselage 101. Hence, both, the bearing ring and the sleeve 104 are rotatable around the fuselage 101. Hence, a rotation between the bearing ring and the sleeve 104 is not necessary.

Alternatively, the bearing ring may be mounted to the fuselage 101 such that the bearing ring is rotatable around the fuselage 101. Hence, both, the bearing ring and the sleeve 104 are rotatable around the fuselage 101. Hence, a rotation between the bearing ring and the sleeve 104 is not necessary. The sleeve 104 is then further movable relative to the bearing ring along the centre axis of the fuselage (or the further rotary axis 102).

Furthermore, the aircraft 100 as shown in FIG. 1 may comprise at a tail section a plurality of tail wings 107 for forming an empennage for example. To the tail wings 107 landing elements 108 may be formed which may be foldable or may be formed in a telescopically manner, such that during landing of the aircraft 100 the landing elements, such as wheels or landing brackets may be activated or deactivated. The landing elements may be extendible and retractable out off or into the empennage, the fuselage or the tail wings 107. Furthermore, the landing elements may comprise an aerodynamic surface such that in an extendible status of the landing elements an additional airflow surface is generated. By the additional airflow surface an improved flight characteristic in particular during landing and starting of the aircraft may be achieved.

Furthermore, as shown in FIG. 1, at the tail section of the aircraft 100 a further propulsion unit 105 may be installed, such that the further propulsion unit 105 generates thrust which acts along e.g. the further rotary axis 102. The further propulsion unit 105 may be for example a rocket engine or a jet engine, for example.

FIG. 2 shows an exemplary adjusting mechanism for adjusting a tilting angle of the wing arrangement 110 under influence of the precession force Fp in more detail. For example, the wing arrangement 110 may be attached to the fuselage 101 by interposing the sleeve 104 and optionally the bearing ring. A first fixing element 201, such as a first fixing bolt, couples the wing arrangement 110 to the sleeve 104. The second fixing element 202, such as a second bolt, couples the wing arrangement 110 through the elongated through hole 106 to the fuselage 101 or to the bearing ring, respectively.

The pivoting axis (i.e. the longitudinal wing axis 112) of the respective wings 113, 114 is defined particularly by the second fixing element 202 which couples the respective wings 113, 114 rotatably to the fuselage 101 or to the bearing ring, respectively. The second fixing element 202, such as a bolt, may be fixed to the fuselage 101 or to the bearing ring, respectively, within a circumferential slot which runs circumferentially around the fuselage 101, such that the second fixing element 202 may run within the slot around the further rotary axis 102, such that the second fixing element 202 may rotate together with the wing arrangement 110.

The first fixing element 201 may be fixed within a guiding slot 205 to the sleeve 104, such that during the tilting of the wing arrangement 110 around the second fixing element 202, the first fixing element 201 may slide along the guiding slot 205 in order to prevent a blockage of the tilting of the wing arrangement 110.

Hence, if the sleeve 104 is moved along the sliding direction 207 (e.g. parallel with the further rotary axis (102) with respect to the fuselage 101 or to the bearing ring, respectively, the first fixing element 201 is moved as well along the fuselage 101 and in particular along the further rotary axis 102, wherein the second fixing element 202 does not change its position along the further rotary axis 102 because it is fixed to the fuselage 101 or to the bearing ring, respectively. Hence, by sliding the sleeve 104 along the further rotary axis 102, a tilting of the wing arrangement 110 around the second fixing element 202 is achieved.

The sliding of the sleeve 104 along the fuselage or along the bearing ring, respectively, and thus along the further rotary axis 102 may be initiated by the precession force Fp and the lifting force Fl. As shown in FIG. 2, the precession force Fp acts on the wing arrangement 110 in a leading edge region 115, in particular on a location, where the rotating mass of the propulsion unit 111 rotates around the rotary axis 117. The precession force Fp is spaced apart from the second fixing element 202 with a distance x1 which forms a first lever arm x1. In a region between the second fixing element 202 and the trailing edge 116 of the wing arrangement 110, the resultant of the lifting force Fl has a point of attack 206 and acts to the wing arrangement 110. The lifting force Fl is spaced in an opposed direction with respect to the precession force Fp from the second fixing element 202 with a second distance which forms a second lever arm x2.

The precession force Fp and the lifting force Fl generates respective opposing turning moments of the wing arrangement 110 around the second fixing element 202. Hence, if the turning moment generated by the precession force Fp and the first lever arm x1 is higher than the moment generated by the lifting force and the second lever arm x2, the wing arrangement 110 is forced to rotate in such a way that an angle of attack α is increased. During the rotation of the wing arrangement 110 around the second fixing element 102, the sleeve 104 slides along the sliding direction 207 and the first fixing element 101 slides within a guiding slot 205 of the sleeve 104, respectively.

The desired tilting angle (i.e. the desired angle of attack α) of the wing arrangement 110 is adjusted, if the moment generated by the precession force is equal to the moment generated by the lifting force Fl:

M(Fp,x1)=M(Fl,x2)

If the moment generated by the lifting force Fl is higher than the moment generated by the precession force Fp, the wing arrangement 110 rotates in such a way that the angle of attack α decreases. Hence, the lifting force Fl decreases as well until a balance of the moment generated by the precession force Fp and the lifting force Fl are balanced. Hence, a self-regulating adjusting mechanism for adjusting a tilting angle of the wing arrangement 110 is presented without leading complex driving mechanism for driving this tilting of the wing arrangement 110.

The angle of attack α is the angle between the cord line 203 of the wing arrangement 110 with respect to the flowing direction 204 of air which results from e.g. the rotation of the wing arrangement 110 through the air.

In order to influence the tilting angle and hence the angle of attack α of the wing arrangement 110, the rotational speed of the wing arrangement 110 around the further rotary axis 102 and the rotational speed of the rotating mass around the rotary axis 117 may be adjusted.

Furthermore, in order to influence the tilting angle and hence the angle of attack α of the wing arrangement 110, a controlling element 103, 103′ may be installed such that the controlling element 103, 103′ generates a controlling force Fd which acts in counter direction to a first rotary direction of the wing arrangement 110 which rotary direction is generated by the precession force Fp. Alternatively, the controlling element 103, 103′ generates a controlling force Fd which acts in the same direction as the first rotary direction of the wing arrangement 110 which rotary direction is generated by the precession force Fp. For example, the controlling element 103 may be a spring which is interposed between the sleeve 104 and the second fixing element 202. Hence, the controlling element 103, i.e. the spring, damps the sliding movement of the sleeve 104 along the fuselage 101, which is initiated by the precession force Fp.

In a further exemplary embodiment, the controlling element 103, 103′ may generate an adjustable controlling force Fd such that a desired controlling force Fd is adjustable. By adjusting the controlling force Fd, e.g. by a servo motor, a worm gear drive and/or by hydraulic components, the desired tilting angle of the wing arrangement 110 is achieved.

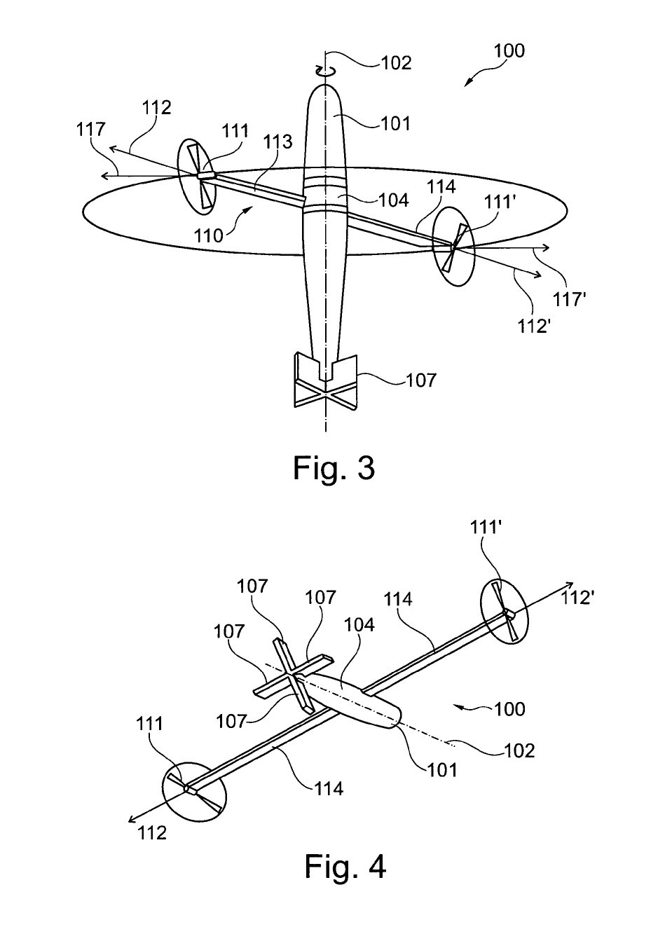

FIG. 3 shows the aircraft 100 in a hover flight mode. The wing arrangement 110 comprises a first wing 113 and a second wing 114 which extends in opposed directions from the fuselage 101. The first wing 113 and the second wing 114 are mounted to the sleeve 104, wherein the first wing 113 and the second wing 114 rotate around the further rotary axis 102 (e.g. the fuselage axis). The rotation of the wings 113, 114 around the further rotary axis 102 is driven by respective propulsion units 111, 111′ which are mounted to the respective wings 113, 114. The propulsion unit 111, 111′ comprises rotating masses (e.g. propellers) which rotates around respective rotary axis 117, 117′ of the propulsion units 111, 111′. The wings 113, 114 are adapted in such a way that in the shown hover flight mode, the wings 113, 114 are tilted around the respective longitudinal wing axis 112, 112′ such that a lifting force Fl is generated due to a rotation of the respective wings 113, 114 around the fuselage 101.

Moreover, FIG. 3 shows the fuselage 101 that comprises e.g. four tail wings 107. The tail wings 107 may balance the fuselage 110 in the hover flight mode and/or a fixed-wing flight mode. Moreover, the tail wings 107 may control the flight direction of the aircraft 110. In an exemplary embodiment, the tail wings 107 may rotate around the longitudinal fuselage axis, e.g. the further rotary axis 102. This rotation of the tail wings 107 may cause a torque that acts against the torque that is induced to the fuselage 110 by the rotation of the wings 113, 114.

FIG. 4 shows the aircraft 100 in a fixed-wing flight mode. In the fixed-wing flight mode, the first wing 113 and the second wing 114 are tilted around the respective longitudinal wing axis 112, 112′ in such a way, that for example the respective chord line 203 of the first wing 113 and the chord line 203 of the second wing 114 run e.g. substantially parallel. The propulsion units 111, 111′ are tilted also in comparison to the hover flight mode shown in FIG. 3 around the respective longitudinal wing axis 112, 112′. In the fixed-wing flight mode, the propulsion units 111, 111′ generates thrust for driving the aircraft 100 in the fixed-wing mode. In the fixed-wing flight mode, the aircraft 100 flights through the air more efficient in comparison to the forward movement in the hover flight mode. The tail wings 107 are used for controlling the flight direction of the aircraft 100. The wings 113, 114 may also comprise controllable surface parts which form e.g. an aileron. Hence, a better controlling of the aircraft during the fixed wing flight mode is achieved.

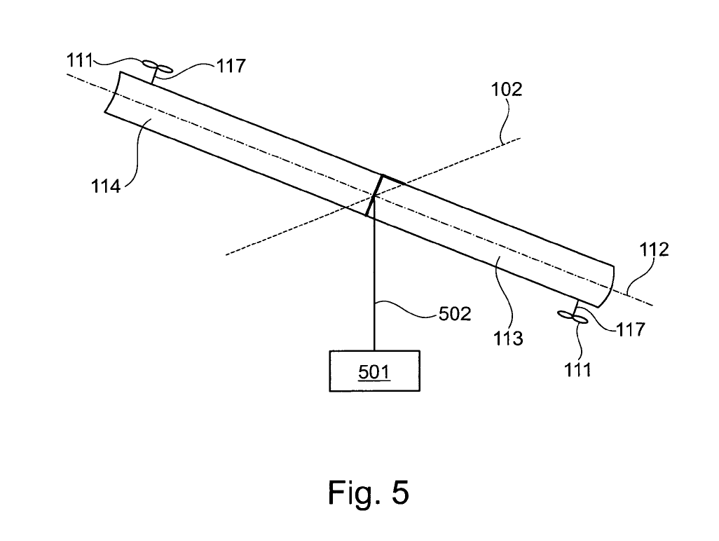

FIG. 5 shows an exemplary embodiment of the device for generating an aerodynamic lift. The device comprises the wing arrangement 110, wherein at both end sections of the wing arrangement 110 a respective propulsion unit 111 is arranged. Each propulsion unit 111 comprises a rotating mass which is rotatable around the rotary axis 117. The wing arrangement 110 is tiltable around the longitudinal wing axis 112. Furthermore, the wing arrangement 110 is rotatable around the further rotary axis 102 that differs to the longitudinal wing axis 112. The adjustment mechanism adjusts the tilting angle of the wing arrangement 110 around the longitudinal wing axis 112 under influence of the procession force Fp which forces the wing arrangement 110 to tilt around the longitudinal wing axis 112.

In the exemplary embodiment of FIG. 5, the wing arrangement 110 is not coupled to a fuselage 101 as shown in the exemplary embodiment shown above. In other words, the wing arrangement 110 is separated in a first wing 113 and a second wing 114. At the contact area of both wings 113, 114 a small fuselage 101 may be formed, wherein the fuselage 101 may be a section of the wing arrangement 110 and thus comprises a length equal to the cord line of the respective wing arrangement 110.

Furthermore, as shown in FIG. 5, a weight 501, such as cargo, to be carried by the device may be fixed by a connection element 502, such as a supporting rope, to the wing arrangement 110 at a rotating point of the wing arrangement 110 around the further rotary axis 102.

Hence, the device forms a flying transporter which may transport weights 501 to desired locations. The device may be for example remote controlled by an operator on the ground.

It should be noted that the term “comprising” does not exclude other elements or steps and “a” or “an” does not exclude a plurality. Also elements described in association with different embodiments may be combined. It should also be noted that reference signs in the claims should not be construed as limiting the scope of the claims.

### LIST OF REFERENCE SIGNS

100 aircraft
101 fuselage
102 further rotary axis
103 controlling element
104 sleeve
105 further propulsion unit
106 elongated through hole
107 tail wing
108 landing element
110 wing arrangement
111 propulsion unit
112 longitudinal wing axis
113 first wing
114 second wing
115 leading edge
116 trailing edge
117 rotary axis
201 first fixing element
202 second fixing element
203 chord line
204 flowing direction of air
205 guiding slot
206 point of attack of lifting force
207 sliding direction of sleeve
501 weight
502 supporting rope
Fp precession force
Ff further force
Fd controlling force
Fl lifting force
α angle of attack
x1 first lever arm
x2 second lever arm

1.-14. (canceled)

15. A device for generating aerodynamic lift, the device comprising:
a wing arrangement which comprises at least one propulsion unit;
wherein the propulsion unit comprises a rotating mass which is rotatable around a rotary axis,
wherein the wing arrangement is tiltable around a longitudinal wing axis of the wing arrangement,
wherein the wing arrangement is rotatable around a further rotary axis that differs to the longitudinal wing axis, and
an adjusting mechanism for adjusting a tilting angle of the wing arrangement around the longitudinal wing axis under influence of a precession force which forces the wing arrangement to tilt around the longitudinal wing axis.

16. The device according to claim 15,
wherein the precession force forces the wing arrangement to tilt around the longitudinal wing axis with a first rotary direction, and
wherein the adjusting mechanism comprises a controlling element having a controlling force which acts in counter direction or in the same direction to the first rotary direction for controlling the tilting of the wing arrangement.

17. The device according to claim 16,
wherein the controlling element comprises a hydraulic damper, a pneumatic damper, a spring, a servo motor and/or a worm gear drive.

18. The device according to claim 16, further comprising:
a control device which is adapted for controlling the controlling force.

19. The device according to claim 18,
wherein the control device is adapted for controlling the controlling force on the basis of data which are indicative of a rotational speed of the rotating mass of the propulsion unit around the rotary axis, a rotational speed of the wing arrangement around the further rotary axis and an angle of attack of the wing arrangement.

20. The device according to claim 15,
wherein the wing arrangement comprises a first wing and a second wing,
wherein the longitudinal wing axis is split in a first longitudinal wing axis and a second longitudinal wing axis,
wherein the first wing extends along the first longitudinal wing axis from the fuselage and the second wing extends along the second longitudinal wing axis from the fuselage,
wherein the first wing is tiltable with a first rotary direction around the first longitudinal wing axis, and
wherein the second wing is tiltable with a second rotational direction around the second longitudinal wing axis.

21. The device according to claim 20,
wherein the first rotational direction differs to the second rotational direction.

22. The device according to claim 15,
wherein the propulsion unit comprises a turbo jet engine, a turbofan engine, a turboprop engine, a propfan engine and/or a propeller engine.

23. An aircraft for vertical take-off and landing, the aircraftcomprising:
a device according to claim 15; and
a fuselage,
wherein the wing arrangement is mounted to the fuselage such that the wing arrangement is tiltable with respect to the fuselage around the longitudinal wing axis and such that the wing arrangement is rotatable with respect to the fuselage around the further rotary axis.

24. The aircraft according to claim 23,
wherein the adjusting mechanism further comprises a sleeve to which the wing arrangement is mounted,
wherein the adjusting mechanism further comprises a bearing ring which is interposed between the sleeve and the fuselage,
wherein the sleeve and the bearing ring are rotatable mounted to the fuselage such that the sleeve and the bearing ring are rotatable around the further rotary axis, and
wherein the sleeve is slidable along the bearing ring for adjusting the tilting angle of the wing arrangement.

25. The aircraft according to claim 24,
wherein the adjusting mechanism comprises a first fixing element and a second fixing element,
wherein the sleeve comprises an elongated through hole,
wherein the first fixing element and the second fixing element are coupled spatially apart from each other to the wing arrangement,
wherein the first fixing element is further coupled to the sleeve, and
wherein the second fixing element is further coupled through the elongated through hole to the bearing ring.

26. The aircraft according to claim 23,
wherein the wing arrangement is adapted in such a way that, in a fixed-wing flight mode, the wing arrangement does not rotate around the further rotary axis, and
wherein the wing arrangement is further adapted in such a way that, in a hover flight mode, the wing arrangement is tilted around the longitudinal wing axis with respect to its orientation in the fixed-wing flight mode and that the wing arrangement rotates around the further rotary axis.

27. The method for operating a device for generating aerodynamic lift according to claim 15, the method comprising:
adjusting a tilting angle of the wing arrangement around the longitudinal wing axis under influence of the precession force which forces the wing arrangement to tilt around the longitudinal wing axis.

28. The method according to claim 27, further comprising:
controlling the precession force:
a) by controlling a rotational speed of the rotating mass of the propulsion unit around the rotary axis,
b) by controlling a rotational speed of the wing arrangement around the further rotary axis and an angle of attack of the wing arrangement,
c) by controlling the weight balance of the rotating mass, and/or
d) by controlling an angle between the rotary axis, the further rotary axis and/or the longitudinal wing axis.
